(19) United States
(12) Patent Application Publication
(10) Pub. No.: US 2017/0278492 A1
(43) Pub. Date: Sep. 28, 2017

(54) DRUM HEAD AND DRUM

(71) Applicant: YAMAHA CORPORATION, Hamamatsu-shi (JP)

(72) Inventor: Ryuji HASHIMOTO, Hamamatsu-shi (JP)

(21) Appl. No.: 15/441,413

(22) Filed: Feb. 24, 2017

(30) Foreign Application Priority Data
Mar. 25, 2016 (JP) 2016-062096

(51) Int. Cl. G10D 13/02

(52) U.S. Cl. CPC G10D 13/027; G10D 13/022

(57) ABSTRACT

A drum head includes: a skin has a plurality of openings arranged along a periphery of the skin; and a reinforcement provided on at least a portion of peripheral edges of the plurality of openings.

### CROSS REFERENCE TO RELATED APPLICATION

The present application claims priority from Japanese Patent Application No. 2016-062096, which was filed on Mar. 25, 2016, the disclosure of which is herein incorporated by reference in its entirety.

### BACKGROUND

The following disclosure relates to a drum head and a drum including the drum head.

In general, acoustic drums produce large sounds when a drum head is struck. Thus, reduction in sound volume is required, depending upon a place where the drum is played and a balance between the volume of sounds produced by the drum and the volume of sounds produced by other musical instruments to be played with the drum. Various constructions for reducing the volume of sounds produced by drums have been proposed.

For example, Patent Document 1 (U.S. Pat. No. 5,637,819) discloses a construction in which various kinds of mute components are attached to a striking side of a drum head and a portion of a back side of the drum head from the striking side. When the drum head is struck, these mute components absorb vibration of the drum head to reduce the volume of sounds produced by the drum head.

Patent Document 2 (Japanese Patent No. 3835084) discloses a drum head having a multiplicity of small holes formed in the entire drum head. The diameter of each of the small holes ranges between one-tenth of several millimeters and several millimeters, for example. This construction reduces an amount of air through which vibrations propagate from the drum head, resulting in reduction of the volume of sounds produced by the drum head.

### SUMMARY

However, in the case of a drum in which the mute components are attached to the drum head as disclosed in Patent Document 1, the length of sustain of sounds produced by strike is considerably shorter than in the case of common drum heads provided with no mute components. That is, a tone color of sounds produced by the drum using the mute components is unclear or unnatural (deteriorated) when compared with a tone color of sounds produced by the common drums.

In the drum head having small holes as disclosed in Patent Document 2, energy loss (i.e., friction loss) is large when air passes into or out of the drum through the small holes, so that the length of sustain of sounds produced by the drum is considerably shorter than that of sounds produced by the common drum heads. As a result, the sounds produced by the drum have an unnatural tone color in which only attack is emphasized.

To reduce the sound volume while providing a natural tone color of sounds produced by common drums, it deems effective to increase the diameter of each of the small holes (hereinafter may be referred to as “openings”) in Patent Document 2 to reduce an amount of air through which vibrations propagate with reduced energy loss. With this construction, however, a natural tone color of sounds produced by the common drums is not provided though the sound volume is reduced. Furthermore, the increased diameter of the opening more easily leads to breakage or deformation of the drum head.

Accordingly, an aspect of the disclosure relates to a technique capable of obtaining a tone color similar to that of sounds produced by common drums, reducing a possibility of breakage or the like due to strike, and reducing the volume of sounds produced by strike.

In one aspect of the disclosure, a drum head includes: a skin having a plurality of openings arranged along a periphery of the skin; and a reinforcement provided on at least a portion of peripheral edges of the plurality of openings.

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIGS. 1A through 1C are views illustrating a drum including a drum head according to a first embodiment;

FIGS. 2A and 2B are views illustrating the drum head;

FIGS. 3A and 3B are views for explaining tension applied to an effective vibration skin in the first embodiment;

FIGS. 4A and 4B are views illustrating a drum head according to a second embodiment;

FIGS. 5A and 5B are views illustrating a drum head according to a third embodiment;

FIGS. 6A and 6B are views illustrating a drum head according to a fourth embodiment;

FIG. 7 is a cross-sectional view illustrating a drum head according to a fifth embodiment;

FIGS. 8A and 8B are views illustrating one example of a drum head according to a sixth embodiment;

FIGS. 9A and 9B are views illustrating another example of the drum head according to the sixth embodiment; and

FIGS. 10A and 10B are views illustrating a drum head according to a seventh embodiment.

### DETAILED DESCRIPTION OF THE EMBODIMENTS

### First Embodiment

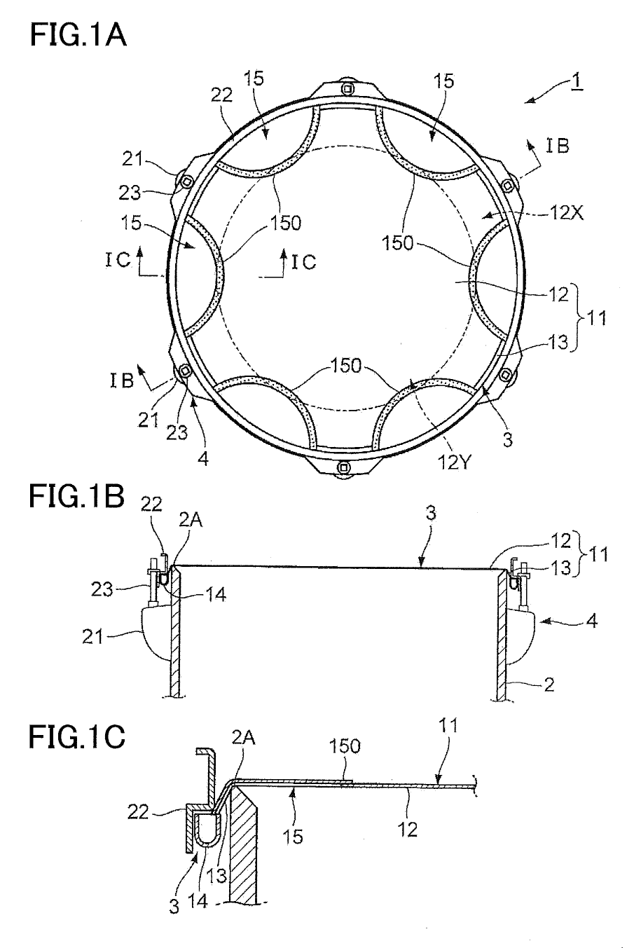

Hereinafter, there will be described embodiments by reference to the drawings. FIGS. 1A and 1B illustrate a drum 1 including a drum head 3 according to a first embodiment. FIG. 1A is a plan view of the drum 1. FIG. 1B is a cross-sectional view taken along line IB-IB in FIG. 1A. FIG. 1C is a cross-sectional view taken along line IC-IC in FIG. 1A. The drum 1 is a tom, for example. As illustrated in FIGS. 1A and 1B, the drum 1 includes: a cylindrical shell (a body) 2; a drum head 3 mounted in one of openings (a one-side opening) of the shell 2 and serving as a striking surface; and a tensioner 4. The shell 2 is formed of a material such as wood and metal.

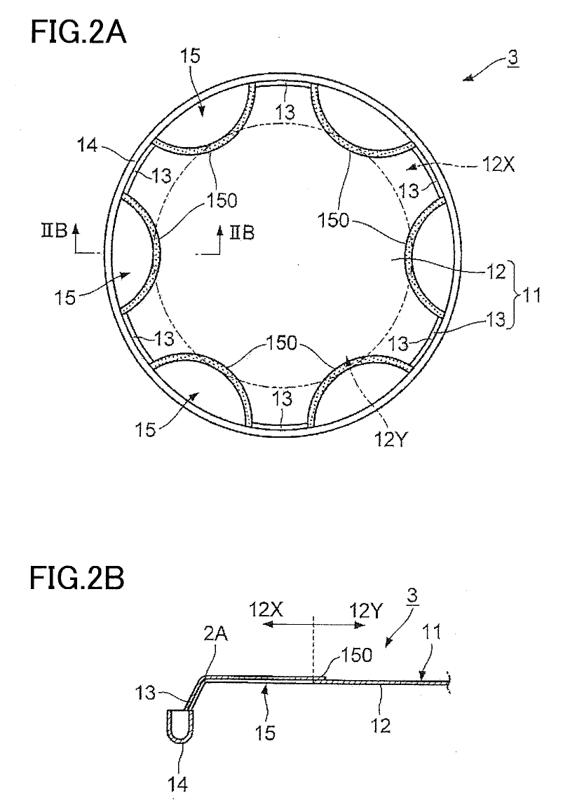

FIGS. 2A and 2B illustrate the drum head 3. FIG. 2A is a plan view of the drum head 3. FIG. 2B is a cross-sectional view taken along line IIB-IIB in FIG. 2A. The drum head 3 includes a flesh hoop 14 and a head portion 11 having a round shape in plan view and constituted by a film formed of polyethylene terephthalate (PET), for example. The flesh hoop 14 is coupled to an outer edge of the head portion 11 and holds the head portion 11. The flesh hoop 14 has an annular shape with its inside diameter being greater than the outside diameter of the shell 2.

The head portion 11 includes: an effective vibration skin 12 located on an inner side of a periphery of the shell 2; and an outer skin 13 located on an outer side of the periphery of the shell 2. The effective vibration skin 12 effectively vibrates when struck in a state in which the drum head 3 is mounted in the one-side opening of the shell 2. The outer skin 13 does not effectively vibrate when the head portion 11 is struck. As illustrated in FIG. 2B, also in a state in which the head portion 11 is not mounted on the shell 2, the outer skin 13 extends from an edge 2A (i.e., a boundary between the effective vibration skin 12 and the outer skin 13) so as to be inclined in the thickness direction of the effective vibration skin 12, toward an outside in the radial direction of the effective vibration skin 12. However, the present disclosure is not limited to this construction.

The head portion 11 is mounted on the shell 2 and tensioned by the tensioner 4. More specifically, the tensioner 4 includes well-known lugs 21, a hoop 22, and tension rods (tuning bolts) 23. The hoop 22 is formed of a material similar to that used for a hoop mounted on a conventional acoustic drum. Examples of the hoop 22 include steel, aluminum, and zinc. The tension rods 23 are screwed into the respective lugs 21. The lugs 21 are uniformly spaced apart from each other in the circumferential direction of the shell 2. When the tension rods 23 screwed into the respective lugs 21 are tightened, the hoop 22 urges the flesh hoop 14 of the drum head 3 from the one-side opening of the shell 2 toward the other opening of the shell 2. As a result, the head portion 11 is stretched in the one-side opening of the shell 2, and tension is applied to the effective vibration skin 12.

As illustrated in FIG. 2A, the effective vibration skin 12 is divided into an outer region 12X and a central region 12Y. The outer region 12X is not or not frequently struck by a player. The central region 12Y is frequently struck by the player. To provide a large-enough area for the central region 12Y, the radius of the central region 12Y is preferably equal to 75% of the radius of the effective vibration skin 12, for example.

The head portion 11 has a plurality of openings 15, each of which is formed in a portion of the outer region 12X and a portion of the outer skin 13. A peripheral edge of each of the openings 15 is smoothly curved. A portion of the opening 15 which is formed in the outer skin 13 is contiguous to the flesh hoop 14.

A portion of the peripheral edge of the opening 15 which is located in the outer region 12X (hereinafter may be referred to as “inner edge”) is curved so as to protrude toward the center of the effective vibration skin 12. In the present embodiment, the length of the opening 15 in the radial direction of the effective vibration skin 12 is less than that of the opening 15 in the circumferential direction of the effective vibration skin 12. As a result, each opening 15 has a large area while providing a large area for the central region 12Y.

The openings 15 have the same shape and the same size. The area of each of the openings 15 in the effective vibration skin 12 is preferably greater than or equal to 78 mm², for example. The openings 15 are uniformly spaced apart from each other in the circumferential direction of the effective vibration skin 12. Each of the openings 15 is symmetric with respect to a line perpendicular to its longitudinal direction. Since the openings 15 having the same shape and the same size and each having symmetry are spaced at regular intervals, the drum head 3 has a symmetric shape even though the openings 15 are formed. Also, all the vibrating modes of the drum head 3 upon strike thereof are close to those of common drum heads. Accordingly, the drum head 3 produces sounds having a tone color close to that of sounds produced by the common drums (i.e., the drums having a drum head without the openings 15) when compared with a drum including a drum head having the openings 15 arranged nonuniformly in the circumferential direction of the effective vibration skin 12.

The drum 1 includes reinforcements 150, each of which is bonded and secured to a corresponding one of portions of the effective vibration skin 12, which portions define the respective peripheral edges of the openings 15. In this specification, a portion of the head portion which defines the peripheral edge of the opening 15 may be referred to as “the peripheral edge of the opening 15” for simplicity. Each of the reinforcements 150 is constituted by a PET film having a thickness of about 100 μm to 250 μm and a width of about 5 mm to 15 mm Each of the reinforcements 150 has stiffness approximately equal to that of the head portion 11 or greater than or equal to that of the head portion 11. The reinforcement 150 is shaped like a ring and secured along the peripheral edge of the opening 15 so as to extend over the outer region 12X and the outer skin 13. Covering the peripheral edge of the opening 15 with the reinforcement 150 reinforces the peripheral edge of the opening 15. Specifically, as illustrated in FIGS. 1A-1C, the reinforcement 150 extends, from the peripheral edge of the opening 15 which is defined by the outer skin 13, via the peripheral edge of the opening 15 which is defined by the outer region 12X, to the peripheral edge of the opening 15 which is defined by the outer skin 13, and the reinforcement 150 is secured along the peripheral edge of the opening 15. With this construction, the peripheral edge of the opening 15 has a high stiffness region having higher stiffness than the other region of the peripheral edge. As illustrated in FIG. 1C, the reinforcement 150 is sandwiched between the flesh hoop 14 and the hoop 22 in a state in which the reinforcement 150 is secured to an upper surface of a portion of the outer skin 13 which defines the opening 15. When the head portion 11 is mounted on the shell 2 and tensioned by the tensioner 4, tension is applied not only to the effective vibration skin 12 but also to the reinforcements 150. The construction of the drum 1 has been described.

In the present embodiment, the length of the opening 15 in the radial direction of the effective vibration skin 12 is less than that of the opening 15 in the circumferential direction of the effective vibration skin 12. Thus, each opening 15 has a large area while providing a large area for the central region 12Y. Also, each opening 15 is formed in the outer skin 13 and the outer region 12X of the effective vibration skin 12. Thus, the large area of the opening 15 does not inhibit playing. Accordingly, an amount of air through which vibrations propagate from the drum head 3 struck by the player decreases by an amount corresponding to the increase in the area of the openings 15, resulting in reduction of volume of sounds produced by the drum 1. Also, energy loss caused when air flows into or out of the drum 1 through the openings 15 is reduced by an amount corresponding to the increase in the area of the openings 15 when compared with the technique disclosed in Patent Document 2. Thus, the length of sustain of sounds produced upon strike can be brought closer to that of sustain of sounds produced by common drums. The inner edges of the respective openings 15 are curved so as to protrude toward the center of the effective vibration skin 12, resulting in uniform tension applied to the effective vibration skin 12. As a result, the tone color of sounds produced in the present embodiment is made further closer to that of the sounds produced by the common drums.

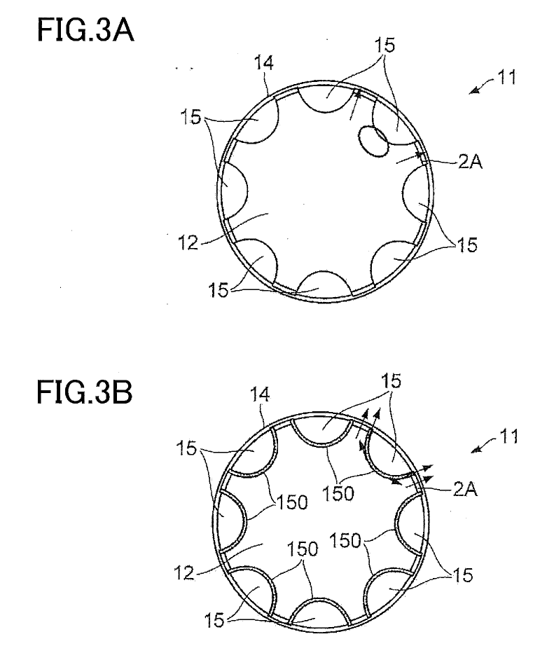

Since the reinforcements 150 are secured to the peripheral edges of the respective openings 15, tension is easily applied to the peripheral edges of the respective openings 15. FIGS. 3A and 3B illustrate tension applied to the effective vibration skin 12. FIG. 3A illustrates the head portion 11 without the reinforcements 150. In this head portion 11, when tension is applied to the effective vibration skin 12 by the tensioner 4, regions between the openings 15 are tensioned in the radial direction of the effective vibration skin 12 (i.e., in directions indicated by arrows in FIG. 3A). However, little tension is applied to the peripheral edge of the opening 15 (i.e., a region circled in FIG. 3A), which may cause a phenomenon in which the peripheral edge of the opening 15 vibrates irregularly and a phenomenon of generation of standing waves having anti-nodes located at the peripheral edges of the openings 15.

In the head portion 11 to which the reinforcements 150 are bonded, in contrast, as illustrated in FIG. 3B, the tension applied by the tensioner 4 acts not only on the regions indicated by the arrows illustrated in FIG. 3A but also on the peripheral edges of the openings 15 (see the arrows illustrated in FIG. 3B). This application of the tension reduces vibrations of the peripheral edges of the openings 15, thereby less frequently leading to the above-described phenomena. As a result, vibrations similar to those of the common drums are produced, thereby preventing production of sounds having an unnatural tone color. Also, a restoration force acts on the peripheral edges of the openings 15, resulting in sustained vibrations with prevention of dissipation of vibration energy. This construction prevents production of sounds having an unnatural tone color with short sustain. Portions of the effective vibration skin 12 along the circumferential direction are tensioned uniformly, so that large tension is not applied locally to a portion of the effective vibration skin 12 which is located near the periphery of the shell 2, thereby preventing breakage or deformation of the effective vibration skin 12 (the outer region 12X).

The peripheral edges of the openings 15 are reinforced by the respective reinforcements 150 secured to the peripheral edges of the respective openings 15, so that the effective vibration skin 12 has high durability and is not broken or deformed even when struck with, e.g., sticks. This high durability reduces a possibility of breakage or other damages to the effective vibration skin 12 due to strike.

In view of the above, it is possible to obtain a tone color similar to that of sounds produced by the common drums, reduce a possibility of breakage or the like due to strike, and reduce the volume of sounds produced by strike.

It is noted that it is possible to increase the stiffness of the peripheral edges of the openings 15 by securing the reinforcement 150 to the entire head portion 11 or increasing the thickness of the entire head portion 11 (the film). In these forms, however, the drum produces sounds having a tone color different from that of sounds produced by the common drums. In addition, the drum may provide deteriorated strike feeling. In the present embodiment, in contrast, the reinforcements 150 are secured only to the peripheral edges of the respective openings 15, thereby achieving the above-described effects without causing such problems.

### Second Embodiment

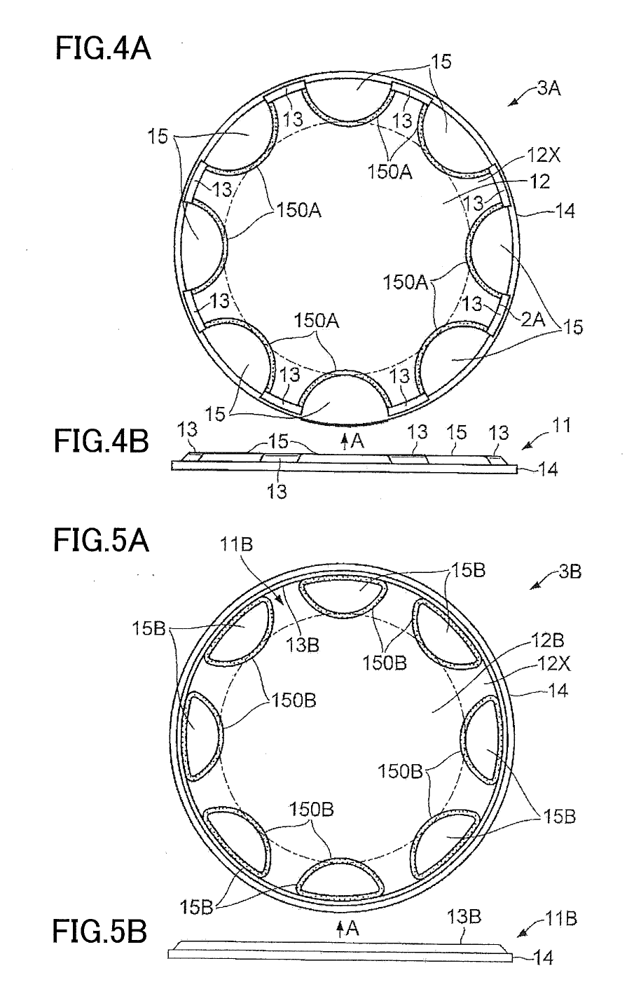

FIGS. 4A and 4B illustrate a drum head 3A according to a second embodiment. FIG. 4A is a plan view of the drum head 3A. FIG. 4B is a side view of the drum head 3A viewed from the direction indicated by the arrow A in FIG. 4A. As illustrated in FIG. 4A, the drum head 3A includes reinforcements 150A. Each of the reinforcements 150A is shaped like an arc and secured only to a portion of the outer region 12X which defines the peripheral edge of a corresponding one of the openings 15. That is, each of the reinforcements 150A is not secured to the peripheral edge of the corresponding opening 15 which is located at the outer skin 13. Opposite end portions of the reinforcement 150A are bonded at positions near the edge 2A, and a portion of the reinforcement 150A between the opposite end portions is smoothly curved and secured to the peripheral edge of the opening 15 (the outer region 12X). Since the construction of the drum head 3A other than the reinforcements 150A is similar to that of the drum head 3, the same reference numerals as used in FIG. 2 are used to designate the corresponding elements in FIG. 4, and an explanation of which is dispensed with. In this second embodiment, the reinforcements 150A may be mounted later on the head portion 11 fixed to the shell 2, providing easy reinforcement of the peripheral edges of the openings 15. This construction saves trouble in manufacturing of the drum head 3, resulting in reduced manufacturing cost. In this embodiment, however, the reinforcements 150A are not secured to the outer skin 13, an amount of tension applied to the peripheral edges of the openings 15 is smaller than that in the first embodiment. Securing method is preferably chosen with attention to this point.

### Third Embodiment

FIGS. 5A and 5B illustrate a drum head 3B according to a third embodiment. FIG. 5A is a plan view of the drum head 3B. FIG. 5B is a side view of the drum head 3B viewed from the direction indicated by the arrow A in FIG. 5A. As illustrated in FIG. 5A, the drum head 3B includes a head portion 11B and reinforcements 150B. The head portion 11B is divided into an effective vibration skin 12B and an outer skin 13B. Openings 15B are formed in the effective vibration skin 12B (only in the outer region 12X). The reinforcements 150B are secured to the respective peripheral edges of the openings 15B along the respective peripheral edges. That is, each of the reinforcements 150B is secured to (i) the peripheral edge of a corresponding one of the openings 15 which is defined by the outer region 12X of the drum head 3B and (ii) an end portion of the outer skin 13B (i.e., an inner portion of the outer skin 13B which is located nearer to the center of the drum head 3B than an outer portion of the outer skin 13B). The reinforcement 150B is different from the reinforcement 150 in that the reinforcement 150B is secured also to the outer peripheral edge of the opening 15B. Since the construction of the drum head 3B other than the above-described elements is similar to that of the drum head 3, the same reference numerals as used in FIG. 2 are used to designate the corresponding elements in FIG. 5, and an explanation of which is dispensed with. The same effects as achieved in the second embodiment are achieved also in this embodiment. In this embodiment, in addition, the openings 15B may be formed in the head portion 11B fixed to the shell 2 later, making it possible to further save trouble in manufacturing of the drum head.

### Fourth Embodiment

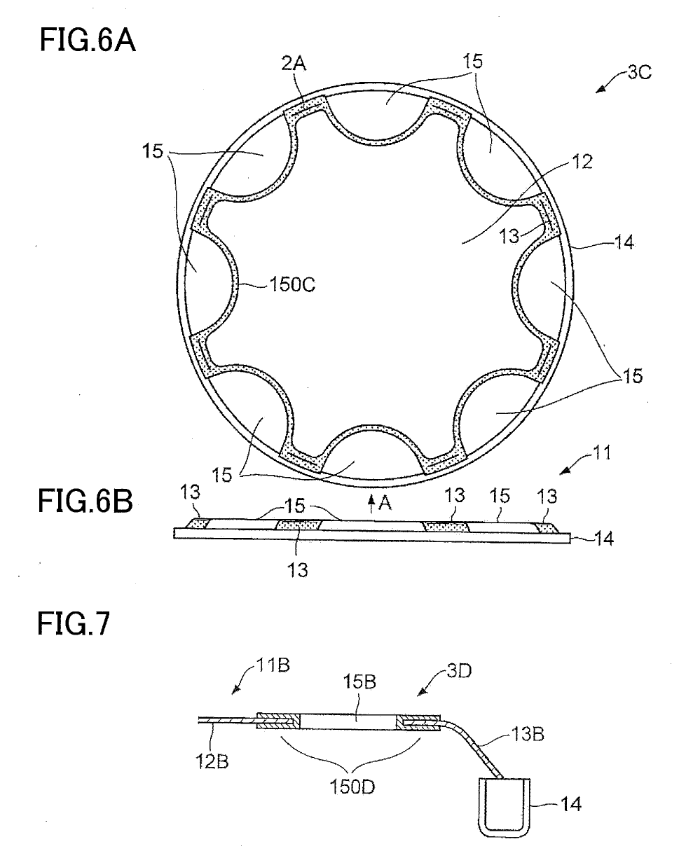

FIGS. 6A and 6B illustrate a drum head 3C according to a fourth embodiment. FIG. 6A is a plan view of the drum head 3C. FIG. 6B is a side view of the drum head 3C viewed from the direction indicated by the arrow A in FIG. 6A. As illustrated in FIG. 6A, the drum head 3C includes a reinforcement 150C. The reinforcement 150C is constituted by a film that has (i) portions secured along the peripheral edges of the respective openings 15 and (ii) portions each connecting between corresponding two of the peripheral edges of the openings 15 near the edge 2A. Since the construction of the drum head 3C other than the reinforcement 150C is similar to that of the drum head 3, the same reference numerals as used in FIG. 2 are used to designate the corresponding elements in FIG. 6, and an explanation of which is dispensed with. In this embodiment, the reinforcement 150C is secured not only to the peripheral edges of the openings 15 but also to the regions each between the corresponding adjacent two peripheral edges of the openings 15. With this construction, the peripheral edges of the openings 15 are further reinforced, and tension applied to the peripheral edges is increased, resulting in enhancement of the effects achieved in the first embodiment. Also, this construction eliminates the need to secure the reinforcement to the peripheral edges of the openings 15 individually, thereby saving trouble in manufacturing of the drum head 3.

### Fifth Embodiment

FIG. 7 is a cross-sectional view illustrating a portion of a drum head 3D according to a fifth embodiment. As illustrated in FIG. 7, the drum head 3D includes reinforcements 150D. The reinforcements 150D are different from the reinforcements 150B in that each of the reinforcements 150D is secured to upper and lower surfaces of the effective vibration skin 12B (the outer region 12X). In the illustrated example, the reinforcement 150D has a three-sided rectangular shape in cross section. Portions of the reinforcement 150D are respectively secured to the upper and lower surfaces of the effective vibration skin 12B such that the effective vibration skin 12B is sandwiched between the portions of reinforcement 150D. Since the construction of the drum head 3D other than the reinforcements 150D is similar to that of the drum head 3B, the same reference numerals as used in FIG. 5 are used to designate the corresponding elements in FIG. 7, and an explanation of which is dispensed with. In this embodiment, the reinforcement 150D is secured not only to the upper surface of the effective vibration skin 12B but also to the lower surface of the effective vibration skin 12B. With this construction, the peripheral edges of the openings 15 are further reinforced, and tension applied to the peripheral edges is increased, resulting in enhancement of the effects achieved in the first embodiment. It is noted that the reinforcements 150 may be individually secured to the upper and lower surfaces of the peripheral edge of the opening 15.

### Sixth Embodiment

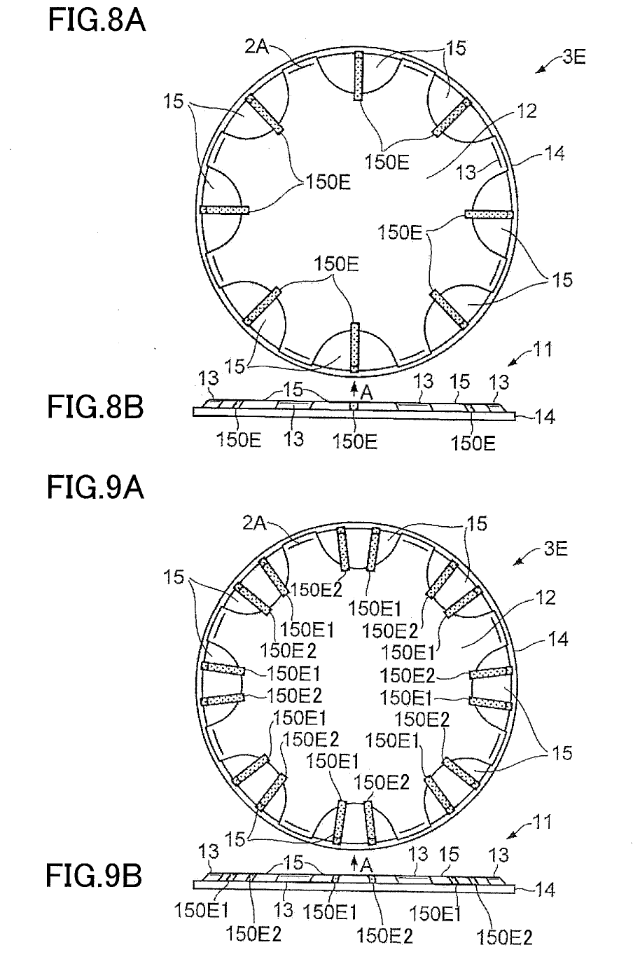

FIGS. 8A and 8B illustrate a drum head 3E according to a sixth embodiment. FIG. 8A is a plan view of the drum head 3E. FIG. 8B is a side view of the drum head 3E viewed from the direction indicated by the arrow A in FIG. 8A. As illustrated in FIG. 8A, the drum head 3E includes reinforcements 150E each having a thin rectangle shape. Each of the reinforcements 150E is secured at its opposite end portions to the peripheral edge of a corresponding one of the openings 15. More specifically, the reinforcement 150E is secured at its opposite end portions to the peripheral edge of the opening 15 so as to extend across the opening 15 near a central portion of the opening 15 in a state in which the longitudinal direction of the reinforcement 150E coincides with the radial direction of the effective vibration skin 12. That is, the reinforcement 150E has a first end and a second end, and the first end nearer to the center of the drum head 3E than the second end is secured to a portion of the peripheral edge of the opening 15 which is located near the center of the drum head 3E while the second end is secured to the flesh hoop 14. The reinforcement 150E crosses the opening 15 in the radial direction of the drum head 3E. Since the construction of the drum head 3E other than the reinforcements 150E is similar to that of the drum head 3, the same reference numerals as used in FIG. 2 are used to designate the corresponding elements in FIG. 8, and an explanation of which is dispensed with. In this embodiment, when tension is applied to the effective vibration skin 12 by the tensioner 4, each of the reinforcement 150E is pulled outward in the radial direction of the effective vibration skin 12 by the flesh hoop 14, so that the peripheral edge of the opening 15 is also tensioned outward in the radial direction of the effective vibration skin 12 via the reinforcement 150E. Accordingly, this construction also increases tension applied to the peripheral edges of the openings 15. In this embodiment, however, the reinforcement of the peripheral edges of the openings 15 is weaker than in the first embodiment. Securing method is preferably chosen with attention to this point.

FIGS. 9A and 9B illustrate a modification of the drum head 3E. As illustrated in FIG. 9A, two reinforcements 150E, namely, a reinforcement 150E1 and a reinforcement 150E2, may be secured for each of the openings 15. The reinforcement 150E1 and the reinforcement 150E2 cross the opening 15 in the radial direction of the drum head 3E. This modification further enhances the above-described effects.

### Seventh Embodiment

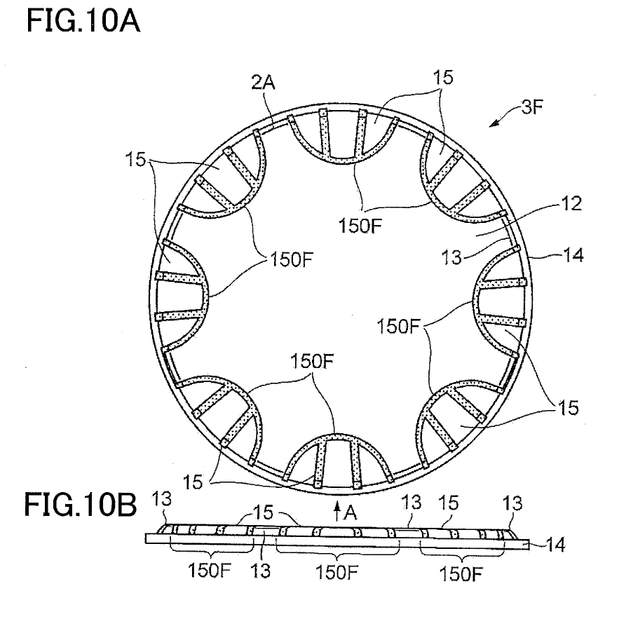

FIGS. 10A and 10B illustrate a drum head 3F according to a seventh embodiment. FIG. 10A is a plan view of the drum head 3F. FIG. 10B is a side view of the drum head 3F viewed from the direction indicated by the arrow A in FIG. 10A. As illustrated in FIG. 10A, the drum head 3F includes reinforcements 150F. Each of the reinforcements 150F is formed by coupling the reinforcement 150, the reinforcement 150E1, and the reinforcement 150E2 to each other. That is, the reinforcement 150F has: a portion secured along the peripheral edge of the opening 15; and portions each crossing the opening 15. More specifically, the reinforcement 150F has: the portion secured along the peripheral edge of the opening 15 which is formed in the outer region 12X; and the two portions extending outward from the portion and secured at their respective outer end portions to the flesh hoop 14. The portions of the reinforcements 150F cross the opening 15 in the radial direction of the drum head 3F. Since the construction of the drum head 3F other than the reinforcements 150F is similar to that of the drum head 3, the same reference numerals as used in FIG. 2 are used to designate the corresponding elements in FIG. 10, and an explanation of which is dispensed with. With this construction, the peripheral edge of the opening 15 is pulled outward more strongly in the radial direction of the effective vibration skin 12, thereby enhancing the effects achieved in the first embodiment.

### Modifications

While the embodiments have been described above, it is to be understood that the disclosure is not limited to the details of the illustrated embodiments, but may be embodied with various changes and modifications, which may occur to those skilled in the art, without departing from the spirit and scope of the disclosure.

Each of the reinforcements 150 is constituted by a component with high density in each of the above-described embodiments other than the sixth embodiment. This construction increases the stiffness of the peripheral edges of the openings 15, thereby enhancing the reinforcement of the peripheral edges of the openings 15. In this case, however, characteristics in higher vibrating modes may change, leading to sounds having a tone color different from that of sounds produced by the common drums. Thus, attention is required in choosing a component or a material.

The reinforcements 150 may be secured only to a lower surface of the head portion 11 in each of the above-described embodiments. The same effects as achieved in each of the above-described embodiments are achieved also in this modification. In addition, the reinforcements 150 are never directly struck with, e.g., sticks during playing in this modification, preventing the impact from separating the reinforcements 150 from the head portion 11. Also, in this modification, even in the case where the thickness of each of the reinforcements 150 is increased to enhance the reinforcement of the peripheral edges of the openings 15, the increased thickness never hinders playing. It is noted that in the construction in which the reinforcements 150 are secured only to the upper surface of the head portion 11 (see FIGS. 1A-1C), a player can recognize a striking position based on a feeling of strike of the reinforcement 150. Accordingly, a method of securing is preferably chosen as needed depending upon characteristics of playing and strength of strike.

Each of the number of the lugs 21 of the tensioner 4 and the number of the tension rods 23 of the tensioner 4 is equal to the number of the openings 15 in each of the above-described embodiments (FIG. 1A) but may be different from the number of the openings 15. In each of the above-described embodiments, the openings 15 and the lugs 21 are alternately arranged in the circumferential direction of the drum head 3 in a state in which the openings 15 are located on an inner side of the periphery of the shell 2, and the lugs 21 are located on an outer side of the periphery of the shell 2. However, the present disclosure is not limited to the above-described positional relationship, and any positional relationship may be employed as needed.

While the reinforcements 150 are secured to the peripheral edges of the respective openings 15 in each of the above-described embodiments, the peripheral edges may be coated with resin. This construction also enhances the reinforcement of the peripheral edges of the openings 15 and increases tension applied to the peripheral edges. Examples of the resin in this modification include photo-curable resin and thermosetting resin.

In each of the above-described embodiments, the reinforcements 150 are respectively secured to at least portions of the peripheral edges of the respective openings 15. The present disclosure is not limited to this configuration. For example, at least one reinforcement 150 may be respectively secured to at least a portion of the peripheral edge of at least one of the openings 15. In this modification, the reinforcements 150 are preferably secured symmetrically, that is, the reinforcements 150 are preferably secured respectively to at least portions of the peripheral edges of each opposite two of the openings 15.

While the reinforcement 150C is coupled to the regions near the edge 2A each between the corresponding adjacent two openings 15 in the above-described fourth embodiment, the construction of the reinforcement 150C is not limited to this construction. The reinforcement 150C only needs to be coupled to at least one region near the edge 2A each between corresponding at least one pair of the openings 15 which are adjacent to each other.

The reinforcement 150C (the fourth embodiment) and the reinforcements 150E (the sixth embodiment) may be coupled to each other. Alternatively, the reinforcement 150C (the fourth embodiment), the reinforcements 150E1, and the reinforcements 150E2 (the seventh embodiment) may be coupled to each other.

What is claimed is:

1. A drum head, comprising:
a skin comprising a plurality of openings arranged along a periphery of the skin; and
a reinforcement provided on at least a portion of peripheral edges of the plurality of openings.

2. The drum head according to claim 1, wherein at least a portion of the reinforcement is provided along at least a portion of the peripheral edges of the plurality of openings.

3. The drum head according to claim 1,
wherein the skin is divided into an inner skin and an outer skin by a portion of the skin, which portion contacts an edge of a shell, and
wherein the reinforcement is secured to the at least the portion of the peripheral edges of the plurality of openings in a state in which the reinforcement crosses the inner skin and the outer skin.

4. The drum head according to claim 1,
wherein the skin is divided into an inner skin and an outer skin by a portion of the skin, which portion contacts an edge of a shell, and
wherein the reinforcement is secured to at least a portion of the peripheral edges of the plurality of openings at the inner skin, and the reinforcement is not secured to the peripheral edges of the plurality of openings at the outer skin.

5. The drum head according to claim 1, wherein the reinforcement is provided over peripheral edges of at least one pair of adjacent openings of the plurality of openings.

6. The drum head according to claim 1, wherein at least a portion of the reinforcement crosses at least one of the plurality of openings.

7. The drum head according to claim 6, wherein the at least the portion of the reinforcement crosses the at least one of the plurality of openings in a radial direction of the skin.

8. The drum head according to claim 1, wherein the reinforcement is provided on at least one of an upper surface and a lower surface of the skin.

9. The drum head according to claim 1, wherein a size of each of the plurality of openings in a circumferential direction of the skin is greater than a size of said each of the plurality of openings in a radial direction of the skin.

10. The drum head according to claim 9, wherein at least a portion of the reinforcement crosses the at least one of the plurality of openings in the radial direction of the skin.

11. A drum comprising a drum head, the drum head comprising: a skin comprising a plurality of openings arranged along a periphery of the skin; and a reinforcement provided on at least a portion of peripheral edges of the plurality of openings.
